(19) United States
(12) Patent Application Publication
(10) Pub. No.: US 2025/0181080 A1
(43) Pub. Date: Jun. 5, 2025

(54) ENVIRONMENT SCRUBBING VIA SWARM DEVICES

(71) Applicant: INTERNATIONAL BUSINESS MACHINES CORPORATION, ARMONK, NY (US)

(72) Inventors: Sarbajit K. Rakshit, Kolkata (IN); Vinod A. Valecha, Pune (IN)

(21) Appl. No.: 18/526,000

(22) Filed: Dec. 1, 2023

(51) Int. Cl. G05D 1/656; B03C 1/32; G05D 105/10

(52) U.S. Cl. CPC G05D 1/656; B03C 1/32; G05D 2105/10

(57) ABSTRACT

A processor may receive environment data associated with a smart environment. The processor may analyze the environment data to identify a scrubbing task associated with the smart environment. The processor may configure a magnetic media based on the scrubbing task. The processor may direct one or more robotic devices to move the magnetic media through the smart environment to perform the scrubbing task, wherein the one or more robotic devices move the magnetic media using one or more magnetic fields.

### BACKGROUND

The present disclosure relates generally to the field of artificial intelligence, and more particularly to the field of smart devices.

Robotic devices and other smart devices have evolved over time to be used in a variety of environments. Robotic devices in particular have become readily available and capable of efficiently accomplishing various tasks. Such technology can be found throughout people's homes and workplaces to assist in performing various tasks. As these devices have grown in popularity, so too has their adaptability to address different needs and perform various tasks.

### SUMMARY

Embodiments of the present disclosure include a method, computer program product, and system for environment scrubbing or removal of one or more objects from an environment.

A processor may receive environment data associated with a smart environment. The processor may analyze the environment data to identify a scrubbing task associated with the smart environment. The processor may configure a magnetic media based on the scrubbing task. The processor may direct one or more robotic devices to move the magnetic media through the smart environment to perform the scrubbing task, wherein the one or more robotic devices move the magnetic media using one or more magnetic fields.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an embodiment of an environment scrubbing system, in accordance with the present disclosure.

FIG. 2 illustrates a flowchart of a method for scrubbing task performance, in accordance with embodiments of the present disclosure.

FIG. 3 depicts a block diagram illustrating an embodiment of a computer system and the components thereof, upon which embodiments described herein may be implemented in accordance with the present disclosure.

FIG. 4 depicts a block diagram illustrating an extension of the computing system environment of FIG. 3, wherein the computer systems are configured to operate in a network environment (including a cloud environment), and perform methods described herein in accordance with the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of artificial intelligence (AI), and more particularly to using smart devices to perform one or more scrubbing tasks in an environment. While the present disclosure is not necessarily limited to such applications, various aspects of the disclosure may be appreciated through a discussion of several examples using this context.

Due to the variety of processes performed in industrial settings and diversity of materials used in such environments, a cornucopia of objects, such as material chips, dust, and spilled solutions may need to be removed (e.g., cleaned) within the industrial setting. While in some situations the cornucopia of objects may be easily removed through traditional cleaning methods, in other situations, traditional cleaning methods may be ineffectual or unable to remove these objects from the environment of interest.

As such there is a desire for a solution that allows for one or more scrubbing tasks (e.g., scrubbing/cleaning scrubbing tasks) to be performed in a smart environment. Embodiments contemplated herein utilize a magnetic media (e.g., magnetic slime) directed by one or more robotic devices (robotic swarm devices) to perform the scrubbing task. For example, a magnetic media may be directed with robotic devices through narrow passages (e.g., areas between closely positioned machinery) or into hard-to-reach areas to clean within a smart environment. The objects located in the particular area of the environment may be collected by the magnetic media. Collection of the objects may occur as a result of the magnetic media's various characteristics (e.g., magnetic strength, viscosity, stickiness, chemical composition, etc.). Once objects are collected by the magnetic media the robotic devices may direct the magnetic media to a waste area where the objects may be removed from the magnetic media.

Before turning to the FIGs. it is noted that the benefits/novelties and intricacies of the proposed solution are that:

The proposed environment scrubbing system may be enabled using Internet of Things (IoT) an artificial intelligence (AI) technology. The environment scrubbing system may be configured in any environment, such as an environment (e.g., industrial floor or industrial factory). Historical learning may be used, at least as a basis, to successively execute scrubbing tasks with the magnetic media and the one or more robotic devices. The environment scrubbing system may control the movement of the magnetic media throughout an environment using the one or more robotic devices through any structure, narrow passage, internal panel etc. The one or more robotic devices may keep an appropriate relative directional mobility and magnetic field magnitude, between each of the one or more robotic devices and/or the magnetic media. The one or more robotic devices may be configured to be moved in a particular pattern to direct the magnetic media while performing the scrubbing task.

The proposed environment scrubbing system may identify an area of activity (e.g., area associated with the scrubbing task), type of scrubbing task, and volume of scrubbing tasks associated with a particular environment (e.g., industrial surrounding). Based on this information, the proposed environment scrubbing system may identify what patterns or movements the magnetic media should take while performing the scrubbing task and ensure the one or more robotic devices are properly positioned to generate the magnetic field and move the magnetic media.

The proposed environment scrubbing system may identify how the magnetic media may move, dimensions of the scrubbing task related area (e.g., passage), such as surface inclination, presence of magnetic and/or non-magnetic material in their environment, the relative positions of each of the one or more robotic devices, ensuring the strength of the one or more magnetic fields are sufficient to move the magnetic media during scrubbing task performance. In some embodiments, one or more robotic devices may be configured within the magnetic media, while one or more other robotic devices may generate a magnetic field external/independent of the magnetic media. The one or more robotic devices within the magnetic media may generate a controlled magnetic field as well as physical force to aid in movement of the magnetic media Based on the characteristics of the magnetic media (e.g., level of viscosity and solidity of the magnetic media) the proposed environment scrubbing system may be configured to identify the required magnitude of the magnetic field and/or physical force needed to move the magnetic media. In such embodiments, the environment scrubbing system may determine how many of the one or more robotic devices may be needed to produce the movement (e.g., perform the scrubbing task). The proposed environment scrubbing system may receive data (e.g., environment data) associated with the magnetic media as it performs the scrubbing task. The proposed environment scrubbing system may determine if there are any changes to the one or more characteristics of the magnetic media as it performs the scrubbing task. In embodiments where there are changes to the one or more characteristics of the magnetic media (e.g., mobility changes), the proposed environment scrubbing system may be configured to identify those changes and make efforts to fix those changes (e.g., add solution to increase mobility).

The proposed environment scrubbing system may merge and/or divide the magnetic media based on the scrubbing task and/or number of scrubbing tasks within an environment. The proposed environment scrubbing system may configure the one or more robotic devices to move, either divided into multiple magnetic media or merged magnetic media, to perform the one or more scrubbing tasks.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be readily understood that the instant components, as generally described and illustrated in the figures herein, may be arranged and designed in a wide variety of different configurations. Accordingly, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow.

Also, any device depicted in the drawings may be a different device. For example, if a mobile device is shown sending information, a wired device could also be used to send the information. The term “module” may refer to a hardware module, software module, or a module may be a combination of hardware and software resources. Embodiments of hardware-based modules may include self-contained components such as chipsets, specialized circuitry, one or more memory devices and/or persistent storage. A software-based module may be part of a program, program code or linked to program code containing specifically programmed instructions loaded into a memory device or persistent storage device of one or more data processing systems operating as part of the computing environment (e.g., environment scrubbing system 100).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

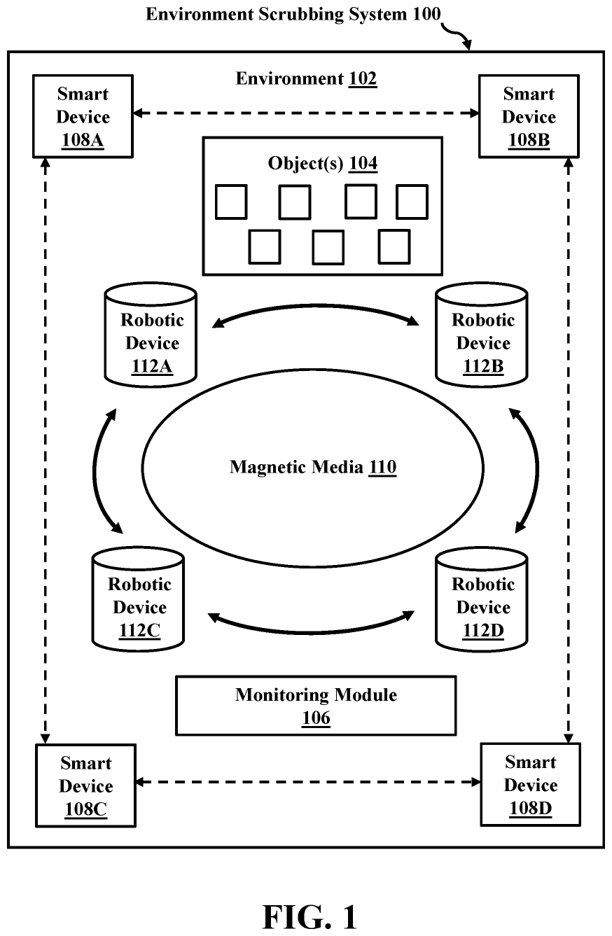

Referring now to FIG. 1, illustrated is a block diagram of an example of environment scrubbing system 100 for performing one or more scrubbing tasks in an environment, in accordance with aspects of the present disclosure. As contemplated herein, a scrubbing task may include any activity where one or more objects 104 are prevented from negatively impacting environment 102. Scrubbing tasks may include, removing, cleaning, or preventing the spread of objects 104 throughout environment 102. FIG. 1 provides an illustration of only one implementation and does not imply any limitations with regard to the various environments in which different embodiments may be implemented. Many modifications to the depicted environment may be made by those skilled in the art without departing from the scope of the invention as recited by the claims.

As depicted in FIG. 1, environment scrubbing system 100 may be configured to include environment 102, objects 104, magnetic media 110, robotic devices 112A-112D (generally referred throughout as robotic devices 112), monitoring module 106, and smart devices 108A-108D (generally referred throughout as smart devices 108). In embodiments, environment 102 may include any environment including, but not limited to industrial/manufacturing floors, buildings, waterpipe systems, structures (e.g., scaffolding), internal structures (e.g., internal housing of machinery), narrow passages or any combination thereof. Environment 102 may have one or more objects 104. Objects 104 may include, but is not limited to dust particles, machining waste (e.g., metal chips), fluids (e.g., spilled solutions), or any other material or substances that may be determined to be an object that should be scrubbed or removed from environment 102.

In embodiments, environment scrubbing system 100 may be configured to receive environment data associated with environment 102. Environment data may include, but is not limited to, information/data associated with: i) the configuration of environment 102, such as the dimensions of the space available, position of potential items within environment 102, and one or more potential objects 104; ii) the number and different types of one or more smart devices 108; iii) information associated with one or more objects 104 (e.g., type of objects, number of objects, attributes associated with each of the one or more objects, etc.); iv) information associated with magnetic media 110 (e.g., types and/or number of magnetic media in environment 102, characteristics of magnetic media 110, etc.); v) information associated with the number, type, and/or position of one or more robotic devices 112 (e.g., position and/or performance of each robotic device during the scrubbing task performance); vi) information associated with the capabilities of robotic devices 112, such as how the robotic device may move through environment 102 (e.g., whether the robotic device have flight capabilities, ground capabilities, and/or climbing capabilities), ability to generate magnetic field (e.g., does the robotic device generate a low/high magnetic field, can the robotic device increase and/or decrease the generate magnetic field, etc.), and additional robotic apparatuses (e.g., robotic arms, telescoping capabilities, scrapers, waste reservoirs, etc.); v) information associated with generating one or more simulations of environment 102 (e.g., a simulation of the real/actual situation of the scrubbing of objects 104 in environment 102 (e.g., performance of scrubbing tasks); vi) information associated with the magnetic media 110, such as characteristics of the magnetic media 110 (e.g., viscosity, solidity, cohesive force, and ability to accumulate objects 104 etc.), changes to the characteristics of magnetic media 110 during and after scrubbing task performance (e.g., number of objects 104 within the magnetic media 110 and reduction in ability of magnetic media to perform scrubbing task performance); vii) information associated with performing the scrubbing task (e.g., movement of magnetic media 110 and/or robotic devices 112); viii) information/data generated from various analyses contemplated herein (e.g., information/data generated by AI and machine learning analysis and related simulations); and ix) databases having information/data associated with the same or similar objects 104 in same or similar scrubbing tasks and/or environments 102 (e.g., databases with information associated with performing various scrubbing tasks and/or various objects 104, and how such objects may be properly disposed of).

In embodiments, environment scrubbing system 100 may be configured to store environment data collected over time in a historical repository. The historical repository may include any environment data contemplated herein. In embodiments, environment scrubbing system 100 may access the historical repository to generate one or more simulations using AI and machine learning capabilities (e.g., using digital twin enabled technology). The information generated from these analyses may be considered environment data and may also be stored within the historical repository.

In embodiments, environment scrubbing system 100 may be configured to collect/receive environment data associated with environment 102 using monitoring module 106. Monitoring module 106 may include one or more smart devices 108. One or more smart devices 108 may include, but are not limited to, Internet of Things (IoT) devices, cameras, infrared sensors, ultrasounds, chemical sensors, smart devices, or any combination thereof. While in some embodiments smart devices 108 may be configured within environment 102 (e.g., positioned on a wall of an industrial floor), in other embodiments smart devices 108 may be at least partially independent of environment 102. In these embodiments, smart devices 108 may be configured within items located in the environment where traditional cleaning methods are ineffective. For example, smart devices 108 may be positioned within a housing or outer case of a machine, within a narrow passageway, and/or within a piping system (e.g., waterpipe system). In some embodiments, smart devices 108 may be configured to move within environment 102 to observe one or more objects 104 more closely. Such embodiments allow environment scrubbing system 100 to collect more accurate environment data associated with one or more objects 104 and the performance of scrubbing tasks in environment 102.

In embodiments, environment scrubbing system 100 may be configured to analyze environment data to identify one or more objects 104 in environment 102. As contemplated herein, one or more objects 104 may be generally understood to be various substances that should be removed from environment 102. For example, in an industrial setting various materials such as dust, metal chips, and other substances may accumulate as a natural side effect of the various industrial processes and machining occurring within a closed space (e.g., environment 102). Though the accumulation of such substances may often be innocuous, in some situations, the buildup may negatively impact the life of a machine and/or result in the creation of hazardous situations (e.g., fire hazard, chemical spill, slip and fall, etc.). While such negative impacts may traditionally be mitigated using traditional cleaning methods, such methods are often ineffective in hard-to-reach areas. Because traditional scrubbing/cleaning methods are often ineffective in these hard-to-reach areas, one or more objects 104 may accumulate in these areas and result in an increased risk of a negative impact.

In some embodiments, environment scrubbing system 100 may determine one or more objects 104 should be scrubbed or removed from environment 102 (e.g., perform a scrubbing task) based on a time interval. For example, environment scrubbing system 100 may be configured to perform one or more scrubbing tasks when environment 102 is not in use. In one example embodiment, environment scrubbing system 100 may determine that there are metal chips from a machining process (e.g., objects 104) that have accumulated in a small crevice (e.g., hard-to-reach area) between machines. In this example embodiment, environment scrubbing system 100 may analyze environment data and determine the time interval where some or all of the machines in environment 102 are offline and not in use. In such embodiments, environment scrubbing system 100 may perform the scrubbing task of removing/cleaning the metal chips from the crevice while the machines are not in use.

In some embodiments, environment scrubbing system 100 may determine one or more objects 104 should be scrubbed or removed from environment 102 (e.g., perform a scrubbing task) based on the amount or different types of objects 104 detected or identified in environment 102. In such embodiments, environment scrubbing system 100 may identify low levels of one or more objects 104 in environment 102 (e.g., in a hard-to-reach area). In these embodiments, environment scrubbing system 100 may continuously analyze the level or amount of the one or more objects 104 over time and determine if the level or amount of the one or more objects 104 increase or accumulate. In situations where the one or more objects 104 level increases over time (e.g., accumulates), environment scrubbing system 100 may determine that the level of the one or more objects 104 meets and/or exceeds a threshold level. In embodiments where environment scrubbing system 100 determines the level of the one or more objects 104 meets and/or exceeds a threshold level, environment scrubbing system 100 may perform the scrubbing task (e.g., clean/remove the one or more objects 104). A threshold level may be based on one or more factors including, but not limited to, the amount or level of objects 104 results in the development of a hazard and/or the amount or level of objects 104 results in the development of a nuisance. In embodiments where environment scrubbing system 100 determines the level of the one or more objects 104 does not meet and/or exceed a threshold level, environment scrubbing system 100 may continue observe and analyze environment 102 (e.g., using real-time environment data).

In an example embodiment, environment scrubbing system 100 may identify that metal chips (e.g., objects 104) are accumulating in a crevice (e.g., hard-to-reach area) in environment 102. Environment scrubbing system 100 may analyze and determine the accumulation (e.g., level and/or amount) of metal chips meets and/or exceeds a threshold level (e.g., creates a hazard). In these embodiments, once environment scrubbing system 100 has determined a threshold level has been met or exceeded, environment scrubbing system 100 may perform the scrubbing task to remove or clean the one or more metal chips from the crevice.

In embodiments, environment scrubbing system 100 may be configured to perform a scrubbing task. As contemplated herein, a scrubbing task may include, but is not limited to, removing, cleaning, and/or preventing the accumulation of one or more objects 104 in environment 102. Environment scrubbing system 100 may perform the one or more scrubbing task using a magnetic media 110 and one or more robotic device 112. In embodiments, environment scrubbing system may be configured to direct one or more robotic devices 112 to move the magnetic media 110 through environment 102 to perform the one or more scrubbing tasks. In such embodiments, environment scrubbing system 100 may configure the one or more robotic devices 112 to move the magnetic media 110 using one or more magnetic fields.

In embodiments, magnetic media 110 may be a combination of one or more materials with sufficient cohesive force (e.g., the strength of bonding between the particles or surface particles that make up the material) to form a viscus globule of varying size and varying adhesiveness (e.g., stickiness) that may be altered based on the identified scrubbing task. Magnetic media 110 may include one or more magnetic and/or paramagnetic materials (e.g., iron, iron oxide, etc.) that allow for magnetic media 110 to be moved in its entirety (e.g., similar to when a magnetic field is applied to magnetic slime), in a particular direction when a particular magnetic field is applied (e.g., via one or more robotic device 112). Magnetic media 110 may be capable of taking a variety of shapes during the performance of the scrubbing task based on the application of one or more magnetic fields via one or more robotic devices 112 and interactions with environment 102 (e.g., magnetic media 110 may contour to the shape of environment 102).

In embodiments, environment scrubbing system 100 may configure one or more robotic devices 112 to collaboratively direct and move magnetic media 110 through environment 102 to perform one or more scrubbing tasks. In embodiments, one or more robotic devices may include several small robots configured to collaboratively move the magnetic media 110 while performing the scrubbing task. Each of the one or more robotic devices 112 may be configured with one or more magnetic fields or other mechanisms that would allow them to magnetically communicate or interact with magnetic media 110 to control or direct magnetic media 110's movement through environment 102. In embodiments, one or more robotic devices 112 may be configured to receive instructions from environment scrubbing system 100 to work collaboratively with each other to direct the magnetic media 110's movement. Such configuration of the robotic devices 112 allows magnetic media 110 to be directed to specific locations within environment 102 (e.g., where the scrubbing task removes object 104 from environment 102). Ensuring the robotic devices 112 are configured to work collaboratively allows magnetic media 110 to be moved in the most efficient and effectively manner.

In embodiments, each of the one or more robotic devices 112 may be configured to generate one or more magnetic fields. The one or more generated magnetic fields may be of sufficient magnetic strength/magnitude to force movement of magnetic media 110. In some embodiments, one or more robotic devices 112 may be configured with electromagnets capable of generating a magnetic field. Environment scrubbing system 100 may configure one or more robotic devices 112 to vary the one or more generated magnetic field during scrubbing task performance, based on how magnetic media 110 may need to be moved throughout environment 102.

In some embodiments, one or more robotic devices 112 may further include actuators, such as motors or pneumatic actuators that may be used to generate a physical force. This physical force may be used to move magnetic media 110 during performance of the scrubbing task. While in some embodiments, one or more robotic devices 112 may use either magnetic communication/interactions or physical force to move magnetic media 110 through environment 102, in other embodiments, one or more robotic devices 112 may use a combination of magnetic communication/interactions or physical force to move magnetic media 110.

In embodiments, the performance of a scrubbing task may include, but is not limited to, the movement of magnetic media 110 and associated robotic devices 112 from the initial starting position (e.g., storage area), the movement of magnetic media 110 and associated robotic devices 112 moving through environment 102 to the location of the one or more objects 104, the movement of magnetic media 110 and associated robotic devices 112 while performing the scrubbing or cleaning, the movement of magnetic media 110 and associated robotic devices 112 from the location of the scrubbing to initial starting area, the movement of magnetic media 110 and associated robotic devices 112 from the location of the scrubbing to a waste reservoir, the movement of magnetic media 110 and associated robotic devices 112 to remove objects 104 from magnetic media 110, or any combination thereof.

In embodiments, environment scrubbing system 100 may analyze environment data and identify a particular scrubbing task, based on identified objects 104 associated with environment 102. Environment scrubbing system 100 may then analyze objects 104 and identify one or more attributes. One or more attributes of objects 104 may include, but are not limited to, chemical composition, volume, object magnetic properties, and location of object 104 in environment 102, or any combination thereof.

In embodiments, environment scrubbing systems 100 may configure magnetic media 110 based on the scrubbing task. More particularly, environment scrubbing systems 100 may alter one or more characteristics of the magnetic media 110, based on the one or more attributes of the one or more objects 104. For example, magnetic media 110 characteristics may include the magnetic properties of the magnetic media, the weight of the magnetic media before the performance of the scrubbing task and the predicted weight after performance of the scrubbing (e.g., when weight of magnetic media 110 may include the additional weight of all or less than all of collected objects 104), the magnetic media 110 viscosity, the magnetic media 110 cohesive force, the magnetic media 110 solidity, and what, if any, additional materials may have been added to magnetic media 110 that may affect the performance of the scrubbing task (e.g., movement controlled by robotic devices 112).

In embodiments, environment scrubbing system 100 may alter one or more of the aforementioned magnetic media characteristics in such a way as to increase the efficiency and efficacy of performing the scrubbing task. In an example embodiment, environment scrubbing system 100 may identify there is dust resulting from machining a hazardous material accumulating through a narrow passage near the ceiling designed to connect utility pipes between rooms. Environment scrubbing system 100 may identify that the objects' attributes are comprised of small particles that may be hazardous if ingested and large volumes of the dust have accumulated in the narrow passage. As indicated above, environment scrubbing system 100 may alter one or more characteristics of magnetic media 110 to collect the dust more effectively and efficiently in the narrow passage. For example, increasing the viscosity and cohesive force of magnetic media 110 may ensure the magnetic media can adhere to surfaces (e.g., climb a wall to a narrow passage near the ceiling). Alternatively, increasing the solidity of magnetic media 110 may result in the magnetic media being durable and resistant to wear and tear. This would allow the magnetic media to be to be reused while also ensuring longer-lasting performance and ideal for use in high-traffic industrial settings.

In some embodiments, additional material may be added to magnetic media 110. This additional material may be used to perform a scrubbing task associated with a particular object. For example, a particular material may be added to magnetic media 110 that will increase the efficiency of removing dust particles from any surface. In some embodiments, the additional material can be removed from magnetic media 110 after the scrubbing task is completed. By removing this additional material allows for the magnetic media 110 to be reused.

In embodiments, environment scrubbing system 100 may configure the one or more robotic devices 112 to move magnetic media 110 during the performance of the scrubbing task. In embodiments, environment scrubbing system 100 may base the configuration of robotic devices 112 on the one or more identified attributes of the one or more objects 104 and the one or more characteristics of magnetic media 110. Environment scrubbing system 100 may configure the one or more robotic devices 112 by changing the one or more capabilities of the robotic devices. These capabilities may include but are not limited to, adjusting the intensity of the generated magnetic field based on magnetic media movement requirements, adjusting the physical force between the robotic devices 112 and magnetic media 110. For example, in embodiments where magnetic media 110 has increased adhesive characteristics (e.g., sticks strongly to surfaces), the one or more robotic devices may be required to use more physical force (e.g., carry magnetic media 110) and less intense magnetic fields. Alternatively, a less adhesive and less viscose magnetic media may be more easily moved using strong magnetic fields.

In embodiments, directing one or more robotic devices to move the magnetic media through the environment to perform the scrubbing task, wherein the one or more robotic devices move the magnetic media using one or more magnetic fields. The one or more magnetic fields may incite movement of magnetic media 110 by orienting the one or more robotic devices 112 with the one or more magnetic fields proximate magnetic media 110. In some embodiments, one or more robotic devices 112 and magnetic media 110 may communicate magnetically to produce movement.

In embodiments, environment scrubbing system 100 may generate, using environment data (e.g., historical data), a simulation of the magnetic media performing the scrubbing task in the environment. In some embodiments, environment scrubbing system 100 may identify a scrubbing task performance plan, wherein the scrubbing task performance plan includes one or more movements of the magnetic media, one or more movements of the one or more robotic devices, and a magnetic level of the one or more magnetic fields.

In embodiments, environment scrubbing system 100 may be configured to use historical information associated with the movement of one or more robotic devices 112 and the magnetic media 110 to perform historical learning analyses. Environment scrubbing system 100 may use historical learning and reinforcement learning (RL) to optimize the movements of one or more robotic devices 112 to control the movement of magnetic media 110. RL is a type of machine learning that may enable environment scrubbing system 100 to make decisions using trial and error. For example, environment scrubbing system 100 may observe the results of the systems historical actions, such as movement of the magnetic medium, and receive a reward or penalty based on whether the environment scrubbing system was able to successfully clean/scrub the area. Over time environment scrubbing system 100 may learn which actions, or the r physical/magnetic forces applied by the robotic devices to the magnetic media 110, led to successful cleaning and which action do not. Based on this feedback, environment scrubbing system 100 would modify its actions for the performance of future scrubbing tasks. Such modification would result in a more efficient and effective cleaning/removal of objects 104 over time.

In embodiments, one or more robotic devices 112 may be configured to utilize swarm intelligence to coordinate the movement of multiple robot devices. In some embodiments, each robotic device 112 may be configured with one or more smart devices (e.g., one or more smart devices 108), such as IoT sensors and communication mechanisms. In embodiments, the communication mechanisms enable each of the one or more robotic devices 112 to collaborate with other robotic devices participating in performing the scrubbing task. In such embodiments, the robotic devices may be configured to determine the optimal position for each of the one or more robotic devices to take proximate to magnetic media 110 through environment 102. For example, if environment scrubbing system 100 detects a particular area in environment 102 having sufficient object 104 to warrant a scrubbing task, environment scrubbing system 100 may instruct the one or more robotic devices 112 to converge on that particular area to ensure the magnetic media 110 is sufficiently supported during performance of the scrubbing task.

In embodiments where the one or more robotic devices 112 incite and control the movement of magnetic media 110 using one or more magnetic fields, the amorphous magnetic media 110 will begin to deform and change shape as one or more magnetic fields are applied and magnetic media 110 beings to move based on the strength, direction, and frequency of the magnetic fields generated by one or more robotic devices 112. In these embodiments, the subsequent deformation from the strength, direction, and frequency of magnetic fields as they repulse and attract magnetic media 110 demonstrates the ability of the magnetic media to change its form and shape into a deformation pattern that can mold into the hard-to-reach areas of environment 102.

In embodiments, the deformation pattern or movement resulting from the repulsive and attractive forces generated by the robotic devices 112, results in magnetic media 110 moving around environment 102. By observing the pattern of deformation of magnetic media 110, the environment scrubbing system 100 may determine how the one or more robotic devices should be moved and configured to perform the scrubbing task. While in some embodiments RL may be used to identify the optimal (e.g., most efficient and effective method of moving magnetic media 110 to perform the scrubbing task), in other embodiments, environment scrubbing system 200 may be configured to generate one or more simulations (e.g., using digital twin technology) to determine how each of the one or more robotic devices 112 should be instructed to move in order to direct or control the movement of magnetic media 110.

In some embodiments, environment scrubbing system 100 may simulate how the presence of items within environment 102 may impact the performance of the scrubbing task. More particularly, environment scrubbing system 100 may simulate and predict how items composed of magnetic, paramagnetic, and non-magnetic materials may impact the movement of magnetic media 110 as it performs the scrubbing task. Based on the magnetic properties (e.g., determined via one or more simulations) of other items in environment 102 the robotic devices 112 may be configured to adjust the one or more magnetic fields to ensure the resultant magnetic force is compatible with performing the scrubbing task. For example, in embodiments where environment scrubbing system 100 detects many non-magnetic materials in environment 102, the one or more robotic devices 112 may need to generate a stronger magnetic force to attract the magnetic media 110 and one or more objects 104, such as dirt and debris from environment 102 surfaces. By analyzing the magnetic properties of items in environment 102, environment scrubbing system 100 may be able to provide a more effective and efficient cleaning or removal of one or more objects 104 from environment 102.

In embodiments, environment scrubbing system 100 may configure the magnetic media 110 and one or more robotic devices 112 to coordinate movements in a collaborative manner. In such embodiments, magnetic media 110 and one or more robotic devices 112 may include one or more smart devices 108. The smart devices of the magnetic media 110 and one or more robotic devices 112 may permit the exchange of information between magnetic media 110 and one or more robotic devices 112. Sharing this information between magnetic media 110 and one or more robotic devices 112 allows for each the magnetic media 110 and the one or more robotic devices 112 to adjust their respective movements (e.g., pattern of deformity) based on the other's actions. For example, if one of the one or more robotic devices 112 detects a particular area that needs additional scrubbing, it can communicate this information to the other robotic devices and the magnetic media 110. Once communicated the one or more robotic devices 112 and magnetic media 110 can work together to focus their cleaning or scrubbing efforts in that particular area. This coordination may allow environment scrubbing system 100 to quickly respond to changes in environment 102 and adjust as needed to ensure effective scrubbing.

In embodiments, environment scrubbing system 100 may collect one or more objects 104 associated with performing the scrubbing task using the magnetic media. In some embodiments, the environment scrubbing system 100 may be configured to remove one or more objects 104 from magnetic media into a waste container or waste reservoir. In these embodiments, additional materials or objects 104 collected in magnetic media 110 during the performance of the scrubbing task may be removed. Methods of removing additional materials and/or objects 104 include, but are not limited to, magnetic separation technique and media washing techniques. By separating the additional material and/or objects 104 from magnetic media 110 allows for the reuse of magnetic media 110 and the additional materials for future scrubbing task. Such embodiments reduce the overall cost and waste associated with cleaning activities.

In embodiments, environment scrubbing system 100 may determine a scrubbing task requires multiple magnetic medias 110 and one or more sets of one or more robotic devices 112. In these embodiments, environment scrubbing system 100 may instruct one or more sets of the one or more robotic devices to move each of the multiple magnetic media through the environment to perform the scrubbing task. The one or more sets of the one or more robotic devices 112 may be configured to work collaboratively to move each magnetic media 110 of the multiple magnetic media using the one or more magnetic fields. In some embodiments, multiple magnetic medias may be utilized while performing scrubbing tasks on larger and/or more complex surfaces in environment 102. In embodiments, environment scrubbing system 100 may merge multiple magnetic medias into a single magnetic media 110 as needed.

In embodiments, environment scrubbing system 100 may determine a scrubbing task requires multiple magnetic medias 110 and one or more sets of one or more robotic devices 112. In such embodiments, environment scrubbing system 100 may instruct one or more sets of the one or more robotic devices 112 to split a single magnetic media into multiple magnetic medias. For example, the one or more robotic devices 112 may divide a single magnetic media 110 into two separate magnetic medias. These two separate magnetic medias may then be configured in different ways to address different scrubbing tasks in environment 102. In embodiments, the one or more robotic devices 112 may be used to control each of the magnetic medias collaboratively and/or or independently of each other. Such embodiments may useful when cleaning small, but different types of objects 104 in environment 102.

In embodiments, environment scrubbing system 100 may preconfigured information associated with magnetic media 110 and different contour types that may be required to perform different scrubbing tasks. In such embodiments, environment scrubbing system 100 may determine the optimal contour of the magnetic media for different scrubbing tasks using pre-existing knowledge (e.g., external databases associated with similar environment 102 and/or similar objects 104). Such pre-existing knowledge/information could be based on previous successful events or experiments that have been conducted with magnetic media and the resulting magnetic media 110 contours that were most effective in capturing dust and debris (e.g., performing a scrubbing task). This pre-existing knowledge may then be used by the environment scrubbing system 100 to quickly determine an appropriate magnetic profile for a particular scrubbing task and object 104 without having to unnecessarily experiment.

In embodiments, environment scrubbing system 100 may be configured to use one or more smart devices 108 (e.g., IoT devices, camera systems, etc.) to analyze and identify types of scrubbing tasks in environment 102 and how environment scrubbing system 100 may identify and generate magnetic media 110 with sufficient contour to perform the scrubbing task in a hard-to-reach area in environment 102. In these embodiments, environment scrubbing system 100 may use one or more smart devices 108 (e.g., IoT devices, camera systems, etc.) to monitor environment 102 and identify the areas associated with scrubbing tasks. Based on the type of scrubbing activity and objects 104, environment scrubbing system 100 may determine the appropriate contour necessary for the magnetic media 110 to effectively perform the scrubbing task. For example, if the scrubbing task includes cleaning a flat surface, the contour of the magnetic media may need to be altered (e.g., changing one or more characteristics of the magnetic media) to generate a flatter shape that will allow for efficient dust particle collection. In another example, if the scrubbing task includes cleaning an irregularly shaped surface, the magnetic media may need to be altered (e.g., changing one or more characteristics of the magnetic media) to generate a contour with a more flexible shape to adapt to the surface's curves. In such embodiments, environment scrubbing system may base these decisions historical data and pre-configured information about scrubbing tasks (e.g., using environment data).

In some embodiments, environment scrubbing system 100 may identify one or more substances (e.g., objects 104) are presently leaking on the floor in environment 102. Environment scrubbing system 100 may identify these one or more leaking substances as a scrubbing task (e.g., meets and/or exceeds a threshold level). In these embodiments, one or more magnetic media 110 may be directed by one or more robotic devices 112 to perform a scrubbing task. In such embodiments, because the leak is ongoing, environment scrubbing system 100 may instruct the one or more robotic devices 112 to deform and contour the one or more magnetic media 110 to create a boundary of fence around the substance (e.g., object 104) to prevent the substance from spreading throughout environment 102. In embodiments where the leak continues leaking the substance into environment 102, environment scrubbing system 100 may instruct additional robotic devices to direct additional magnetic media (e.g., where the one or more characteristics of the additional magnetic media are altered to address the substance attributes) to the location of the substance. In some embodiments, the additional magnetic medias may be configured to merge with the magnetic medias already performing the scrubbing task to form a larger, potentially more useful magnetic media capable of reducing the substance from spreading throughout environment 102.

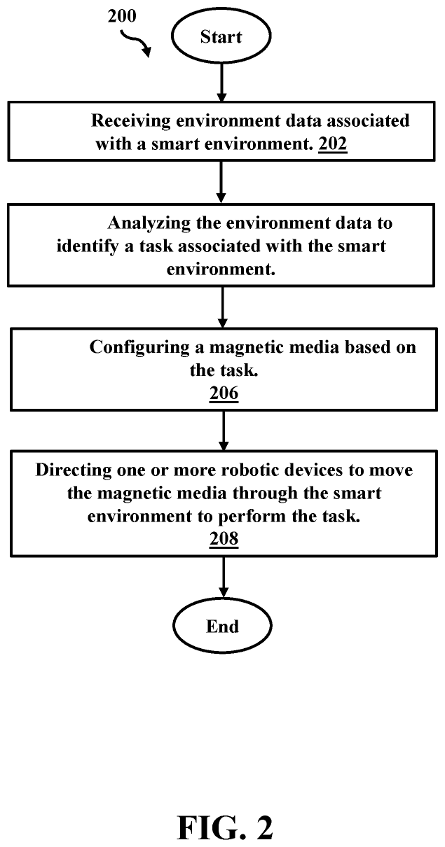

Referring now to FIG. 2, a flowchart illustrating an example method 200 for scrubbing task performance in a smart environment, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202. At operation 202 a processor may receive environment data associated with a smart environment.

At operation 204, the processor may analyze the environment data to identify a scrubbing task associated with the smart environment. The method 200 proceeds to operation 206.

At operation 206, the processor may configure a magnetic media based on the scrubbing task. The method 200 proceeds to operation 208.

At operation 208, the processor may direct one or more robotic devices to move the magnetic media through the smart environment to perform the scrubbing task. In some embodiments, the one or more robotic devices may move the magnetic media using one or more magnetic fields. In some embodiments, as depicted in FIG. 2, after operation 208, the method 200 may end.

In some embodiments, discussed below there are one or more operations of the method 200 not depicted for the sake of brevity and which are discussed throughout this disclosure. Accordingly, in some embodiments, the processor, while configuring the magnetic media, may identify one or more objects in the smart environment from the environment data (e.g., via one or more data collection devices). In these embodiments, the processor may analyze one or more objects in the smart environment associated with the scrubbing task using the environment data. In these embodiments, the processor may identify one or more attributes of the one or more objects. The processor may then alter one or more characteristics of the magnetic media (e.g., viscosity, magnetic capability, etc.). This alteration of the one or more characteristics of the magnetic media may be based on the one or more attributes of the one or more objects.

In embodiments, the processor may analyze the magnetic media and one or more objects in the smart environment associated with the scrubbing task using the environment data. In these embodiments, the processor may identify one or more attributes of the one or more objects and one or more characteristics of the magnetic media. The processor may configure the one or more robotic devices based on the one or more attributes of the one or more objects and the one or more characteristics of the magnetic media. In some embodiments, the processor may collect the one or more objects associated with the scrubbing task using the magnetic media. In some embodiments, the processor may remove the one or more objects from the magnetic media into a waste container.

In embodiments, the processor may generate a simulation of the magnetic media performing the scrubbing task in the smart environment. This may be performed using environment data. In these embodiments, the processor may identify a scrubbing task performance plan, wherein the scrubbing task performance plan includes one or more movements of the magnetic media, one or more movements of the one or more robotic devices, and a magnetic level of the one or more magnetic fields.

In embodiments where the processor is instructing the one or more robotic devices, the processor may generate the one or more magnetic fields of the one or more robotic devices. In these embodiments, the processor may use the magnetic fields associated with the robotic devices to incite movement of the magnetic media by orienting the one or more robotic devices with the one or more magnetic fields proximate the magnetic media, wherein the one or more robotic devices and the magnetic media communicate magnetically to produce movement (e.g., the magnetic fields of the robotic devices interacting with the magnetic characteristics of the magnetic media).

In some embodiments, the processor may determine that the identified scrubbing task requires multiple magnetic media and one or more sets of one or more robotic devices. In these embodiments, the processor may instruct one or more sets of the one or more robotic devices to move (e.g., in concert) each of the multiple magnetic media through the smart environment to perform the scrubbing task. In some embodiments, the one or more sets of the one or more robotic devices may work collaboratively to move each magnetic media of the multiple magnetic media using the one or more magnetic fields.

It is noted that various aspects of the present disclosure are described by narrative text, flowcharts, block diagrams of computer systems and/or block diagrams of the machine logic included in computer program product (CPP) embodiments. With respect to any flowcharts (depending upon the technology involved) the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination thereof. A computer-readable storage medium should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection, but this does not render the storage device as transitory because the data is not transitory while it is stored.

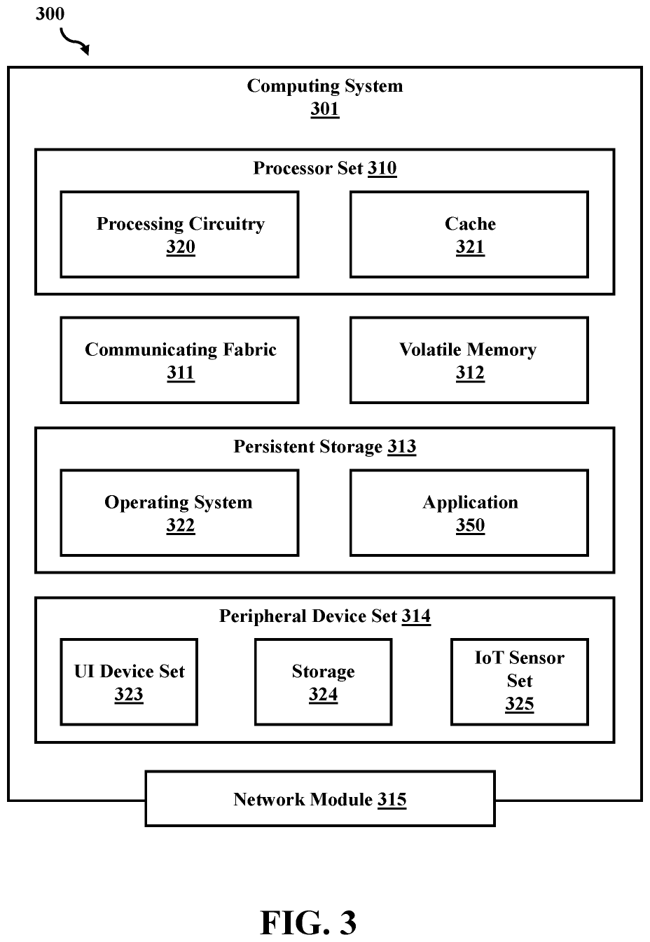

Referring now to FIG. 3, illustrated is a block diagram describing an embodiment of a computing system 301 within in a computing environment, which may be a simplified example of a computing device (i.e., a physical bare metal system and/or a virtual system) capable of performing the computing operations described herein. Computing system 301 may be representative of the one or more computing systems or devices implemented in accordance with the embodiments of the present disclosure and further described below in detail. It should be appreciated that FIG. 3 provides only an illustration of one implementation of a computing system 301 and does not imply any limitations regarding the environments in which different embodiments may be implemented. In general, the components illustrated in FIG. 3 may be representative of an electronic device, either physical or virtualized, capable of executing machine-readable program instructions.

Embodiments of computing system 301 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running a program 350, accessing a network 302 or querying a database, such as remote database 330. Performance of a computer-implemented method executed by a computing system 301 may be distributed among multiple computers and/or between multiple locations. Computing system 301 may be located as part of a cloud network, even though it is not shown within a cloud in FIGS. 3-2. Moreover, computing system 301 is not required to be in a cloud network except to any extent as may be affirmatively indicated.

Processor set 310 includes one, or more, computer processors of any type now known or to be developed in the future. Processing circuitry 320 may be distributed over multiple packages. For example, multiple, coordinated integrated circuit chips. Processing circuitry 320 may implement multiple processor threads and/or multiple processor cores. Cache 321 may refer to memory that is located on the processor chip package(s) and/or may be used for data or code that can be made available for rapid access by the threads or cores running on processor set 310. Cache 321 memories can be organized into multiple levels depending upon relative proximity to the processing circuitry 320. Alternatively, some, or all of cache 321 of processor set 310 may be located “off chip.” In some computing environments, processor set 310 may be designed for working with qubits and performing quantum computing.

Computer readable program instructions can be loaded onto computing system 301 to cause a series of operational steps to be performed by processor set 310 of computing system 301 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 321 and the other storage media discussed herein. The program instructions, and associated data, can be accessed by processor set 310 to control and direct performance of the inventive methods. In computing environments of FIGS. 3-2, at least some of the instructions for performing the inventive methods may be stored in persistent storage 313, volatile memory 312, and/or cache 321, as application(s) 350 comprising one or more running processes, services, programs and installed components thereof. For example, program instructions, processes, services and installed components thereof may include the components and/or sub-components of the system 100 as shown in FIG. 1.

Communication fabric 311 may refer to signal conduction paths that may allow the various components of computing system 301 to communicate with each other. For example, communications fabric 311 can provide for electronic communication among the processor set 310, volatile memory 312, persistent storage 313, peripheral device set 314 and/or network module 315. Communication fabric 311 can be made of switches and/or electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 may refer to any type of volatile memory now known or to be developed in the future, and may be characterized by random access, but this is not required unless affirmatively indicated. Examples include dynamic type random access memory (RAM) or static type RAM. In computing system 301, the volatile memory 312 is located in a single package and can be internal to computing system 301, but, alternatively or additionally, the volatile memory 312 may be distributed over multiple packages and/or located externally with respect to computing system 301. Application 350, along with any program(s), processes, services, and installed components thereof, described herein, may be stored in volatile memory 312 and/or persistent storage 313 for execution and/or access by one or more of the respective processor sets 310 of the computing system 301.

Persistent storage 313 can be any form of non-volatile storage for computers that may be currently known or developed in the future. The non-volatility of this storage means that the stored data may be maintained regardless of whether power is being supplied to computing system 301 and/or directly to persistent storage 313. Persistent storage 313 may be a read only memory (ROM), however, at least a portion of the persistent storage 313 may allow writing of data, deletion of data and/or re-writing of data. Some forms of persistent storage 313 may include magnetic disks, solid-state storage devices, hard drives, flash-based memory, erasable read-only memories (EPROM) and semi-conductor storage devices. Operating system 322 may take several forms, such as various known proprietary operating systems or open-source Portable Operating System Interface type operating systems that employ a kernel.

Peripheral device set 314 includes one or more peripheral devices connected to computing system 301. For example, via an input/output (I/O interface). Data communication connections between the peripheral devices and the other components of computing system 301 may be implemented using various methods. For example, through connections using Bluetooth, Near-Field Communication (NFC), wired connections or cables (such as universal serial bus (USB) type cables), insertion type connections (for example, secure digital (SD) card), connections made though local area communication networks and/or wide area networks such as the internet. In various embodiments, UI device set 323 may include components such as a display screen, speaker, microphone, wearable devices (such as goggles, headsets and smart watches), keyboard, mouse, printer, touchpad, game controllers, and haptic feedback devices. Storage 324 can include external storage, such as an external hard drive, or insertable storage, such as an SD card. Storage 324 may be persistent and/or volatile. In some embodiments, storage 324 may take the form of a quantum computing storage device for storing data in the form of qubits. In some embodiments, networks of computing systems 301 may utilize clustered computing and components acting as a single pool of seamless resources when accessed through a network by one or more computing systems 301. For example, a storage area network (SAN) that is shared by multiple, geographically distributed computer systems 301 or network-attached storage (NAS) applications. IoT sensor set 325 can be made up of sensors that can be used in Internet-of-Things applications. For example, a sensor may be a temperature sensor, motion sensor, infrared sensor or any other type of known sensor type.

Network module 315 may include a collection of computer software, hardware, and/or firmware that allows computing system 301 to communicate with other computer systems through a network 302, such as a LAN or WAN. Network module 315 may include hardware, such as modems or Wi-Fi signal transceivers, software for packetizing and/or de-packetizing data for communication network transmission, and/or web browser software for communicating data over the network. In some embodiments, network control functions and network forwarding functions of network module 315 are performed on the same physical hardware device. In other embodiments (for example, embodiments that utilize software-defined networking (SDN)), the control functions and the forwarding functions of network module 315 can be performed on physically separate devices, such that the control functions manage several different network hardware devices. Computer readable program instructions for performing the inventive methods can typically be downloaded to computing system 301 from an external computer or external storage device through a network adapter card or network interface included in network module 315.

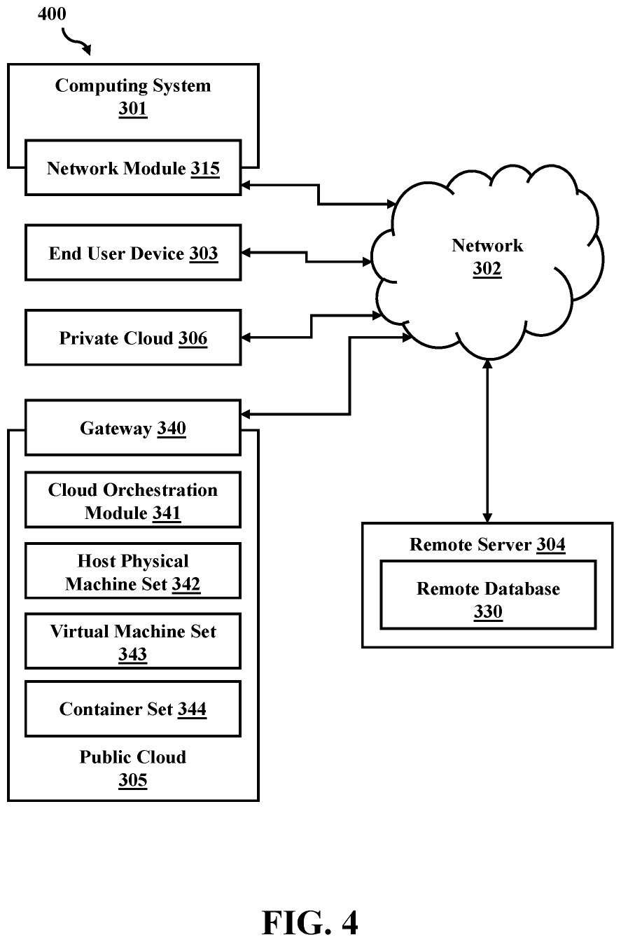

Continuing, FIG. 4 depicts a computing environment 400 which may be an extension of the computing environment 300 of FIG. 3, operating as part of a network. In addition to computing system 301, computing environment 400 can include a network 302 such as a wide area network (WAN) (or another type of computer network) connecting computing system 301 to an end user device (EUD) 303, remote server 304, public cloud 305, and/or private cloud 306. In this embodiment, computing system 301 includes processor set 310 (including processing circuitry 340 and cache 321), communication fabric 311, volatile memory 312, persistent storage 313 (including operating system 322 and program(s) 350, as identified above), peripheral device set 314 (including user interface (UI), device set 323, storage 324, Internet of Things (IoT) sensor set 325), and network module 315. Remote server 304 includes remote database 330. Public cloud 305 includes gateway 340, cloud orchestration module 341, host physical machine set 342, virtual machine set 343, and/or container set 344.

Network 302 may be comprised of wired or wireless connections. For example, connections may be comprised of computer hardware such as copper transmission cables, optical transmission fibers, wireless transmission, routers, firewalls, switches, gateway computers and/or edge servers. Network 302 may be described as any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. Other types of networks that can be used to interconnect the various computer systems 301, end user devices 303, remote servers 304, private cloud 306 and/or public cloud 305 may include Wireless Local Area Networks (WLANs), home area network (HAN), backbone networks (BBN), peer to peer networks (P2P), campus networks, enterprise networks, the Internet, single tenant or multi-tenant cloud computing networks, the Public Switched Telephone Network (PSTN), and any other network or network topology known by a person skilled in the art to interconnect computing systems 301.

End user device 303 can include any computer device that can be used and/or controlled by an end user (for example, a customer of an enterprise that operates computing system 301) and may take any of the forms discussed above in connection with computing system 301. EUD 303 may receive helpful and useful data from the operations of computing system 301. For example, in a hypothetical case where computing system 301 is designed to provide a recommendation to an end user, this recommendation may be communicated from network module 315 of computing system 301 through WAN 302 to EUD 303. In this example, EUD 303 can display, or otherwise present, the recommendation to an end user. In some embodiments, EUD 303 may be a client device, such as thin client, thick client, mobile computing device such as a smart phone, mainframe computer, desktop computer and so on.

Remote server 304 may be any computing systems that serves at least some data and/or functionality to computing system 301. Remote server 304 may be controlled and used by the same entity that operates computing system 301. Remote server 304 represents the machine(s) that collect and store helpful and useful data for use by other computers, such as computing system 301. For example, in a hypothetical case where computing system 301 is designed and programmed to provide a recommendation based on historical data, the historical data may be provided to computing system 301 from remote database 330 of remote server 304.

Public cloud 305 may be any computing systems available for use by multiple entities that provide on-demand availability of computer system resources and/or other computer capabilities including data storage (cloud storage) and computing power, without direct active management by the user. The direct and active management of the computing resources of public cloud 305 can be performed by the computer hardware and/or software of cloud orchestration module 341. The computing resources provided by public cloud 305 can be implemented by virtual computing environments that run on various computers making up the computers of host physical machine set 342, and/or the universe of physical computers in and/or available to public cloud 305. The virtual computing environments (VCEs) may take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through network 302.

VCEs can be stored as “images.” A new active instance of the VCE can be instantiated from the image. Two types of VCEs may include virtual machines and containers. A container is a VCE that uses operating-system-level virtualization, in which the kernel allows the existence of multiple isolated user-space instances, called containers. These isolated user-space instances may behave as physical computers from the point of view of programs 350 running in them. An application 350 running on an operating system 322 can utilize all resources of that computer, such as connected devices, files and folders, network shares, CPU power, and quantifiable hardware capabilities. Applications 350 running inside a container of container set 344 may only use the contents of the container and devices assigned to the container, a feature which may be referred to as containerization.

Private cloud 306 may be similar to public cloud 305, except that the computing resources may only be available for use by a single enterprise. While private cloud 306 is depicted as being in communication with network 302 (such as the Internet), in other embodiments a private cloud 306 may be disconnected from the internet entirely and only accessible through a local/private network. A hybrid cloud may refer to a composition of multiple clouds of different types (for example, private, community or public cloud types), and the plurality of clouds may be implemented or operated by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 may be both part of a larger hybrid cloud environment.

What is claimed is:

1. A computer-implemented method for scrubbing an environment, comprising:
receiving, by a processor, environment data associated with an environment;
analyzing the environment data to identify a scrubbing task associated with the environment;
configuring a magnetic media based on the scrubbing task; and
directing one or more robotic devices to move the magnetic media through the environment to perform the scrubbing task, wherein the one or more robotic devices move the magnetic media using one or more magnetic fields.

2. The computer-implemented method of claim 1, wherein configuring the magnetic media further includes:
analyzing one or more objects in the environment associated with the scrubbing task using the environment data;
identifying one or more attributes of the one or more objects; and
altering one or more characteristics of the magnetic media, based on the one or more attributes of the one or more objects.

3. The computer-implemented method of claim 1, further comprising:
analyzing the magnetic media and one or more objects in the environment associated with the scrubbing task using the environment data;
identifying one or more attributes of the one or more objects and one or more characteristics of the magnetic media; and
configuring the one or more robotic devices based on the one or more attributes of the one or more objects and the one or more characteristics of the magnetic media.

4. The computer-implemented method of claim 3, further including:
collecting the one or more objects associated with the scrubbing task using the magnetic media; and
removing the one or more objects from the magnetic media into a waste container.

5. The computer-implemented method of claim 1, further comprising:
generating, using environment data, a simulation of the magnetic media performing the scrubbing task in the environment; and
identifying a scrubbing task performance plan, wherein the scrubbing task performance plan includes one or more movements of the magnetic media, one or more movements of the one or more robotic devices, and a magnetic level of the one or more magnetic fields.

6. The computer-implemented method of claim 1, wherein instructing the one or more robotic devices
generating the one or more magnetic fields of the one or more robotic devices; and
inciting movement of the magnetic media by orienting the one or more robotic devices with the one or more magnetic fields proximate the magnetic media, wherein the one or more robotic devices and the magnetic media communicate magnetically to produce movement.

7. The computer-implemented method of claim 1, further comprising:
determining a scrubbing task requires multiple magnetic media and one or more sets of one or more robotic devices; and
instructing the one or more sets of the one or more robotic devices to move each of the multiple magnetic media through the environment to perform the scrubbing task, wherein the one or more sets of the one or more robotic devices work collaboratively to move each magnetic media of the multiple magnetic media using the one or more magnetic fields.

8. A system, the system comprising:
a memory; and
a processor in communication with the memory, the processor being configured to perform operations comprising:
receive environment data associated with an environment;
analyze the environment data to identify a scrubbing task associated with the environment;
configure a magnetic media based on the scrubbing task; and
direct one or more robotic devices to move the magnetic media through the environment to perform the scrubbing task, wherein the one or more robotic devices move the magnetic media using one or more magnetic fields.

9. The system of claim 8, wherein the operation of configuring the magnetic media further includes:
analyze one or more objects in the environment associated with the scrubbing task using the environment data;
identify one or more attributes of the one or more objects; and
alter one or more characteristics of the magnetic media, based on the one or more attributes of the one or more objects.

10. The system of claim 8, the operations further comprising:
analyze the magnetic media and one or more objects in the environment associated with the scrubbing task using the environment data;
identify one or more attributes of the one or more objects and one or more characteristics of the magnetic media; and
configure the one or more robotic devices based on the one or more attributes of the one or more objects and the one or more characteristics of the magnetic media.

11. The system of claim 10, the operations further including:
collect the one or more objects associated with the scrubbing task using the magnetic media; and
remove the one or more objects from the magnetic media into a waste container.

12. The system of claim 8, the operations further comprising:
generate, using environment data, a simulation of the magnetic media performing the scrubbing task in the environment; and
identify a scrubbing task performance plan, wherein the scrubbing task performance plan includes one or more movements of the magnetic media, one or more movements of the one or more robotic devices, and a magnetic level of the one or more magnetic fields.

13. The system of claim 8, wherein the operation of instructing the one or more robotic devices further includes:
generate the one or more magnetic fields of the one or more robotic devices; and
incite movement of the magnetic media by orienting the one or more robotic devices with the one or more magnetic fields proximate the magnetic media, wherein the one or more robotic devices and the magnetic media communicate magnetically to produce movement.

14. The system of claim 8, the operations further comprising:
determine a scrubbing task requires multiple magnetic media and one or more sets of one or more robotic devices; and
instruct the one or more sets of the one or more robotic devices to move each of the multiple magnetic media through the environment to perform the scrubbing task, wherein the one or more sets of the one or more robotic devices work collaboratively to move each magnetic media of the multiple magnetic media using the one or more magnetic fields.

15. A computer program product, the computer program product comprising a computer readable storage medium having program instructions embodied therewith, the program instructions executable by a processor to cause the processors to perform a function, the function comprising:
receive environment data associated with an environment;
analyze the environment data to identify a scrubbing task associated with the environment;
configure a magnetic media based on the scrubbing task; and
direct one or more robotic devices to move the magnetic media through the environment to perform the scrubbing task, wherein the one or more robotic devices move the magnetic media using one or more magnetic fields.

16. The computer program product of claim 15, wherein the function of configuring the magnetic media further includes:
analyze one or more objects in the environment associated with the scrubbing task using the environment data;
identify one or more attributes of the one or more objects; and
alter one or more characteristics of the magnetic media, based on the one or more attributes of the one or more objects.

17. The computer program product of claim 15, the functions further comprising:
analyze the magnetic media and one or more objects in the environment associated with the scrubbing task using the environment data;
identify one or more attributes of the one or more objects and one or more characteristics of the magnetic media; and
configure the one or more robotic devices based on the one or more attributes of the one or more objects and the one or more characteristics of the magnetic media.

18. The computer program product of claim 17, the functions further including:
collect the one or more objects associated with the scrubbing task using the magnetic media; and
remove the one or more objects from the magnetic media into a waste container.

19. The computer program product of claim 15, the functions further comprising:
generate, using environment data, a simulation of the magnetic media performing the scrubbing task in the environment; and
identify a scrubbing task performance plan, wherein the scrubbing task performance plan includes one or more movements of the magnetic media, one or more movements of the one or more robotic devices, and a magnetic level of the one or more magnetic fields.

20. The computer program product of claim 15, wherein the function of instructing the one or more robotic devices further includes:
generate the one or more magnetic fields of the one or more robotic devices; and
incite movement of the magnetic media by orienting the one or more robotic devices with the one or more magnetic fields proximate the magnetic media, wherein the one or more robotic devices and the magnetic media communicate magnetically to produce movement.
